(19) United States
(12) Patent Application Publication
(10) Pub. No.: US 2014/0227649 A1
(43) Pub. Date: Aug. 14, 2014

(54) METHOD AND APPARATUS FOR DELIVERING A HIGH VOLTAGE TO A FLAME-COUPLED ELECTRODE

(71) Applicant: ClearSign Combustion Corporation, Seattle, WA (US)

(72) Inventors: Igor A. KRICHTAFOVITCH, Kirkland, WA (US); Christopher A. WIKLOF, Everett, WA (US)

(73) Assignee: ClearSign Combustion Corporation, Seattle, WA (US)

(21) Appl. No.: 14/179,375

(22) Filed: Feb. 12, 2014

Related U.S. Application Data
(60) Provisional application No. 61/763,544, filed on Feb. 12, 2013.

(51) Int. Cl. F23N 5/00; H01R 43/00

(52) U.S. Cl. CPC F23N 5/00; H01R 43/00
USPC 431/253; 29/593; 29/857

(57) ABSTRACT

A high voltage electrical signal can be conveyed to an electrode in a combustion volume operatively coupled to a burner or a flame supported by the burner. A high voltage source in a region external to the combustion volume can convey the high voltage electrical signal to the electrode via a propagation path including an electrical bushing. The electrode and electrical bushing can be configured for field installation. Field installation can include a use of only simple tools.

### CROSS-REFERENCE TO RELATED APPLICATIONS

The present application claims priority benefit from U.S. Provisional Patent Application No. 61/763,544, entitled “METHOD AND APPARATUS FOR DELIVERING A HIGH VOLTAGE TO A FLAME-COUPLED ELECTRODE”, filed Feb. 12, 2013; which, to the extent not inconsistent with the disclosure herein, is incorporated by reference.

### SUMMARY

According to an embodiment, a system configured for electrical control of a combustion reaction includes a high voltage source in a region external to a combustion volume, a high voltage propagation path from the high voltage source to the combustion volume, and one or more electrodes disposed in the combustion volume, operatively coupled to the high voltage propagation path, and configured to (at least intermittently) apply an electrical signal to a flame supported by a burner in the combustion volume. The high voltage propagation path includes an electrical bushing including a conductor, a dielectric insulator structure disposed peripheral to the conductor, and an electrical bushing coupling disposed peripheral to the dielectric insulator structure. The electrical bushing is configured for in-field installation or replacement.

According to an embodiment, a method for installing an electrode disposed relative to a flame in a combustion volume includes inserting an electrode into a combustion volume through an aperture defined by a combustion volume coupling; then coupling, to the combustion volume coupling, an electrical bushing including a conductor in electrical continuity with the electrode, and coupling an external terminal of the electrical bushing conductor to a high voltage source. The electrical bushing is structured to allow alignment to the flame or a burner supporting the flame. The electrical bushing supports the electrode and provides a keyed alignment.

### BRIEF DESCRIPTION OF THE DRAWINGS

FIG. 1 is a diagram of a system for applying electrical energy to a flame in a combustion volume, according to an embodiment.

FIG. 2A is a side-sectional view of a portion of the system of FIG. 1 including an electrical bushing and a flame-coupled electrode, according to an embodiment.

FIG. 2B is a side-sectional view of the bushing and electrode assembly of FIG. 2A in a position corresponding to insertion through the combustion volume coupling, according to an embodiment.

FIG. 3 is a flow chart showing a method for installing the electrical bushing and electrode of FIGS. 1 and 2, according to an embodiment.

### DETAILED DESCRIPTION

In the following detailed description, reference is made to the accompanying drawings, which form a part hereof. In the drawings, similar symbols typically identify similar components, unless context dictates otherwise. Other embodiments may be used and/or other changes may be made without departing from the spirit or scope of the disclosure.

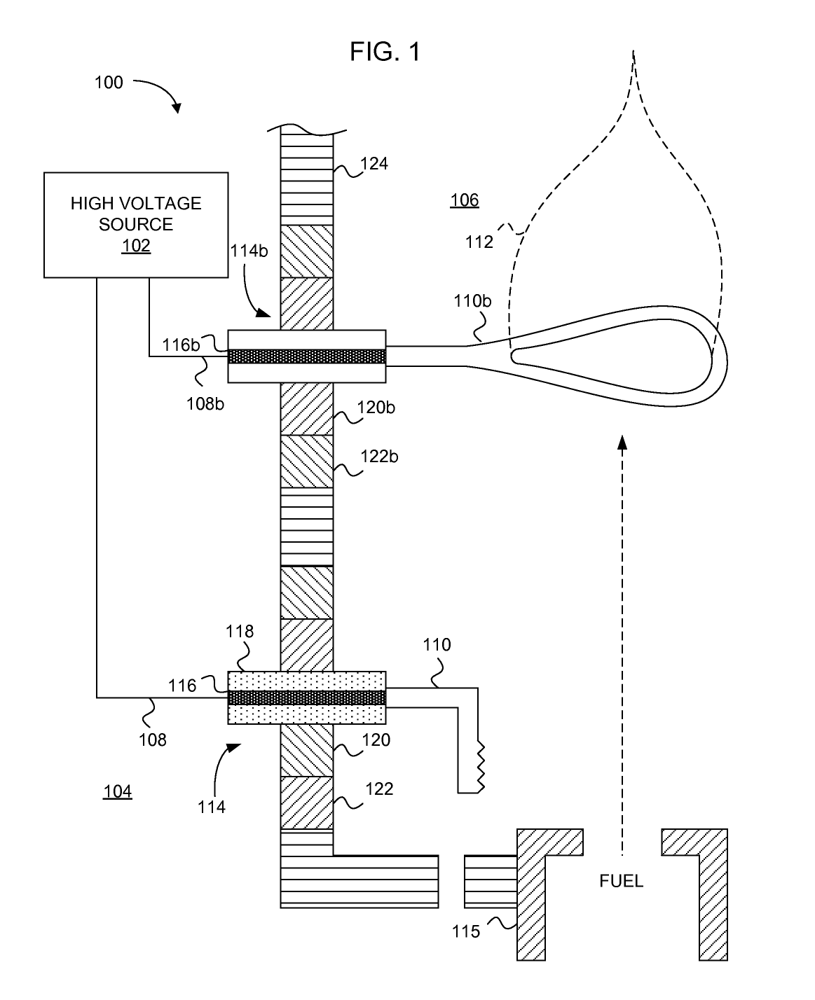

FIG. 1 is a diagram of a system 100 for applying electrical energy to a flame 112 in a combustion volume 106, according to an embodiment. The system 100 is configured for electrical control of a combustion reaction 112. The system 100 can include a high voltage source 102 in a region 104 external to a combustion volume 106. A voltage propagation path 108 from the high voltage source 102 to the combustion volume 106 is configured to make a circuit with one or more electrodes 110, 110b disposed in the combustion volume 106. A ground propagation path 108b completes the circuit to the high voltage source 102. The one or more electrodes 110, 110b are operatively coupled to the high voltage propagation path 108, and are configured to (at least intermittently) apply an electrical signal to a fuel stream output by a fuel nozzle 115 or to a flame 112 supported by the fuel nozzle 115. The high voltage propagation path 108 is preferably insulated to prevent shorting of a +/−10 kilovolt or larger voltage signal carried on a conductor between the high voltage source 102 and the electrode 110.

The voltage propagation paths 108, 108a include an electrical bushing 114, 114b. The electrical bushing 114, 114b includes a conductor 116, 116b, a dielectric insulator structure 118, 118b disposed peripheral to the conductor 116, 116b, and a coupling 120, 120b disposed peripheral to the dielectric insulator structure 118. The electrical bushing 114 is configured for in-field installation or replacement. The electrode 110 and bushing 114 can form an electrode and bushing assembly configured for coupling to a combustion volume coupling 122. The electrode 110b and bushing 114b can similarly be provided as an electrode and bushing assembly configured for coupling to a combustion volume coupling 122b.

The electrical bushing 114 can couple to the electrode 110 so as to pass the high voltage through a combustion volume wall 124. In some embodiments, the combustion volume wall 124 includes a water tube boiler wall. In other embodiments, the combustion volume wall 124 includes a furnace wall that may optionally be formed at least partially from refractory structures (e.g., insulation or refractory brick). In other embodiments, the combustion volume wall 124 can include a plenum wall and/or burner housing configured to separate a combustion volume from the environment 104 outside of the boiler or furnace system. For example, some burner designs include a housing 124 that contains a chamber adjacent to a fuel nozzle and/or combustion air supply. The electrical bushing 114, 114b can be configured to mechanically support an electrode 110, 110b shaped for support inside and for passage through a volume defined by a burner housing. Preferably, the electrode 110, 110b is supported sufficiently far away from grounded conductive surfaces so as not to arc discharge to ground. Additionally or alternatively, any portion of the electrode 110, 110b that might be adjacent to a grounded surface can be insulated. For example, the electrode insulation can include fused quartz glass. Optionally, an electrode that does not need a conductive surface in contact with the flame 112 or other region of the combustion volume 106 can include quartz glass or other high temperature insulation that forms an unbroken barrier with the dielectric insulator structure 118 of the electrical bushing 114. Optionally, the “outer” ends of the electrical bushing conductor 116 can be disposed inside an outer housing configured for access by a technician or engineer. Optionally, the high voltage source can be disposed inside the outer housing.

The bushing 114b can also be used to convey signal ground into the combustion volume 106. In the embodiment 100, during operation, the electrode 110 is driven to a high voltage of about 40 kilovolts. Sharp projections (also referred to as serrations) form a corona electrode configured to eject charge into a fuel stream emitted by a fuel nozzle 115. The electrode 110b can be held at signal ground or at a voltage opposite in polarity to the high voltage placed on the electrode 110. The flame 112 is held by the electrode 110b by action of charges carried into the flame 112 by the fuel stream.

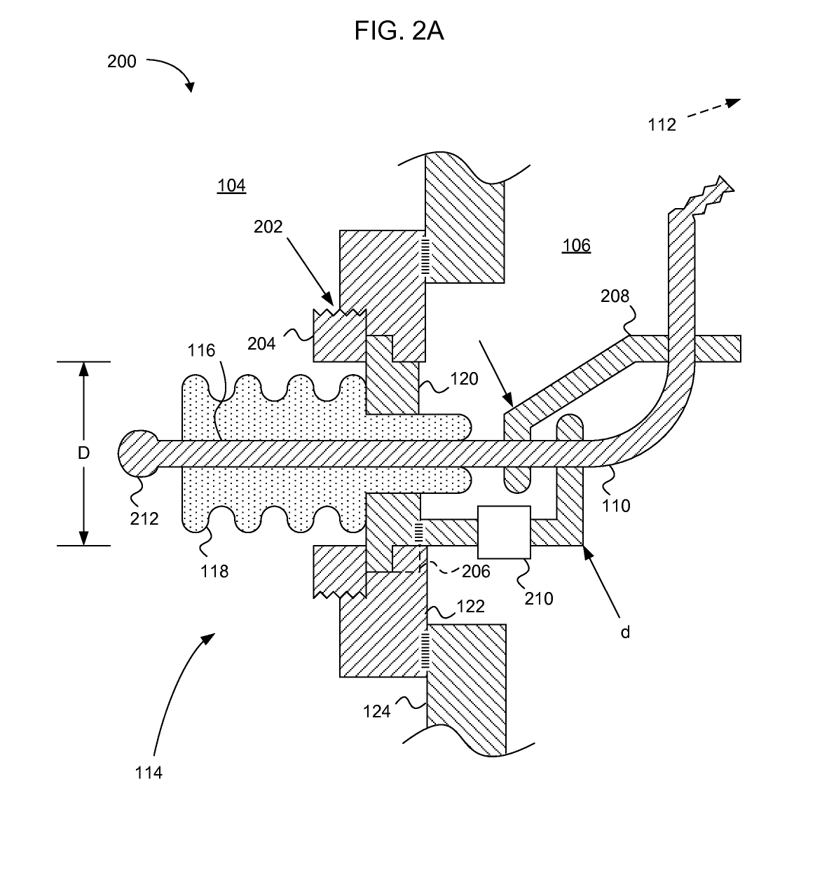

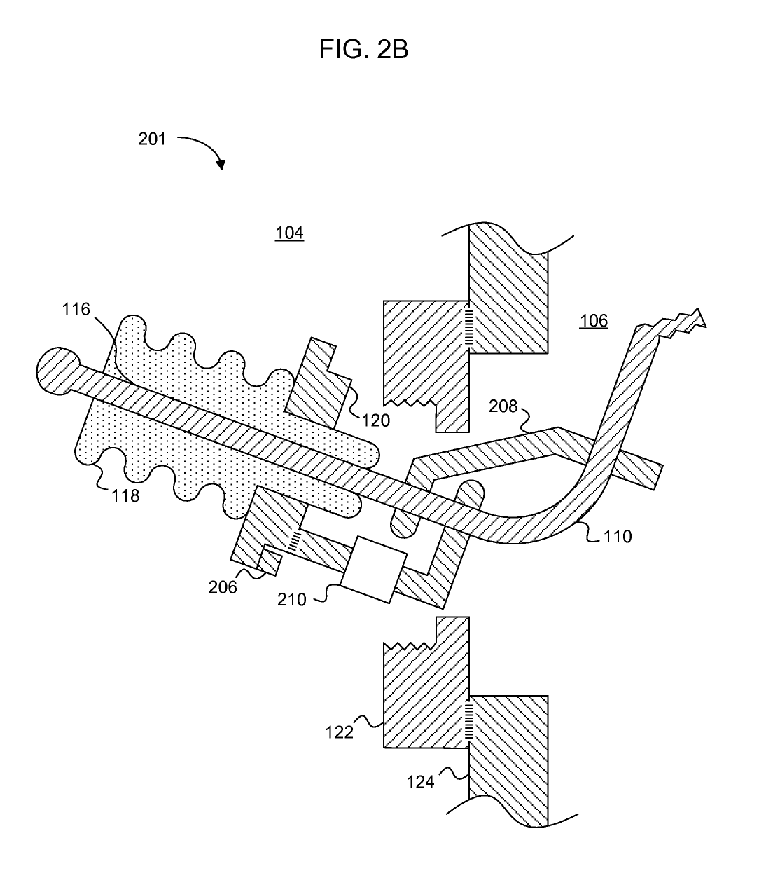

FIG. 2 is a side-sectional view 200 of a portion of the system of FIG. 1 including the electrical bushing 114 and a flame-coupled electrode 110, according to an embodiment. FIG. 2B is a side sectional view 201 the bushing and electrode assembly of FIG. 2A in a position corresponding to insertion through the combustion volume coupling 122, according to an embodiment. Referring to FIG. 1, FIG. 2A and FIG. 2B, the electrical bushing 114, 114b can be configured for fastening using one or more clamps 204, and can be configured for installation and/or replacement using hand tools. The electrical bushing 114, 114b can be configured for replacement without removing the fuel nozzle 115 or other portions of the burner.

In some embodiments, the electrical bushing 114, 114b and an integrated electrode 110, 110b can be configured for screw fitting into a threaded combustion volume coupling 122. For example, a threaded electrical bushing coupling 120, 120b can be screwed into a threaded combustion volume coupling 122, 122b against a crush washer. In a preferred embodiment, the electrical bushing coupling 120, 120b is configured for sliding insertion into a corresponding combustion volume coupling 122, 122b. The electrical bushing coupling 120, 120b with a sliding fitting can be configured to be clamped into the corresponding combustion volume coupling 122, 122b. (For example, see the external threaded 202 clamp 204 shown in FIG. 2A.) For example, the electrical bushing coupling 120 can be configured to form a coupling akin to a union fitting in combination with the corresponding combustion volume coupling 122. Accordingly, the electrical bushing coupling 120, 120b can be configured to be rotationally free relative to a corresponding combustion volume coupling 122, 122b, at least during installation.

Providing rotational freedom to the electrical bushing 114, 114b can be used, for example, for an installer to align an electrode 110, 110b supported by the electrical bushing 114, 114b to the fuel nozzle 115 and/or the flame 112. In another embodiment (as depicted in FIGS. 2A and 2B), the electrical bushing 114 can be keyed to the combustion volume coupling 122. Providing a key to a combustion volume coupling 122, 122b can be useful for maintaining a factory-selected relationship between an electrode 110, 110b and the fuel nozzle 115 and flame 112. In another embodiment, the electrical bushing 114, 114b and the combustion volume coupling 122, 122b can include a gauge, template, and/or actuator configured to select a rotational angle relative to a key on the other of the combustion volume or electrical bushing coupling 120/122, 120b/122b. Providing a gauge, template, and/or actuator configured to select a rotational angle relative to a key on the mating part (or an interrelationship between a gauge, template, and/or actuator on the mating part) can be useful for establishing a known initial relationship between the electrode 110, 110b and the fuel nozzle 115 and/or flame 112. Additionally or alternatively, providing a gauge, template, and/or actuator configured to select a rotational angle relative to a key on the mating part (or an interrelationship between a gauge, template, and/or actuator on the mating part) can be useful for making running adjustments to a spatial relationship between the electrode 110, 110b and the fuel nozzle 115 and/or flame 112.

According to an embodiment, at least one electrode 110, 110b can be configured to be supported by the electrical bushing 114, 114b in substantial electrical isolation from a combustion volume wall 124 for electrical interaction with the flame 112. The electrode 110, 110b can extend from the bushing conductor 116, 116b and/or can be continuous with the bushing conductor 116, 116b, such that the electrode 110, 110b is an extension of the bushing conductor 116, 116b.

The electrical bushing 114 can be operatively coupled to an electrode support 208. The electrode support 208 can be operatively coupled to the dielectric insulator structure 118 or to the conductor 116 in electrical continuity with the electrode 110. The electrode support 208 can include a tension member, a compression member, and/or a stiffening member. The tension member, compression member, and/or stiffening member can be configured to maintain alignment between the electrode 110 and the flame 112.

The electrode 110 (and optional electrode support 208) has a characteristic dimension d that represents the widest extent that needs to be inserted through an inner diameter D defined by the combustion volume coupling 122. In some embodiments, the electrode 110 and/or electrode support 208 has a fixed shape that defines d. Alternatively, the electrode 110 and/or electrode support 208 can be flexible such that a nominal dimension d can be squeezed during installation (and removal) to fit through a smaller combustion volume coupling dimension D. In this embodiment, the electrode 110 and/or electrode support 208 can be formed from spring steel.

The electrical bushing coupling 120 can be configured to cooperate with a corresponding combustion volume coupling 122 to provide a low-resistance conduction path to ground from the electrical bushing coupling 120 to the combustion volume coupling 122.

The electrical bushing 114 can include a resistor 210 operatively coupled between the conductor 116 or electrode 110 and the bushing coupling 120. The resistor 210 is provided to pull the electrode 110, the conductor 116 and the voltage path 108 to ground when voltage is turned off at the voltage source 102. To minimize power dissipation and maintain voltage at the electrode 110, the electrical resistor 210 preferably has a relatively high resistance. For example, for an electrode configured to couple to ground through the flame 112, the operating resistance to ground can typically be about 6 to 8 mega-ohms. In a DC high voltage system, the resistor 210 can be selected to have a resistance of about 600 mega-ohms (e.g., nominally 560 mega-ohms) to cause a 10 kilovolt to 100 kilovolt voltage on the electrode 110 to bleed to ground according to a selected time constant when the flame 112 is not present. For example, in a 40 kilovolt DC system with 0.2 nano-farad output terminal capacitance at the high voltage source 102, selecting a 600 mega-ohm resistance on the resistor 210 will produce an RC time constant, τ=R*C, of 0.12 seconds. This will cause the 40 kilovolt voltage to bleed to less than 40 volts in 1.8 seconds (15*τ). Putting 600 mega-ohms in parallel with 6-8 mega-ohm flame resistance will not add appreciable power dissipation to the system.

The resistor 210 can operate as a safety mechanism to prevent a high capacitance floating electrode 110 from discharging through a person who may contact the conductor 116 when removing the electrode 110 for replacement. The electrical resistor 210 can optionally be integrated with the dielectric insulator structure 118.

Optionally, the electrical resistor 210 can be omitted.

The high voltage source 102 can be configured to (at least intermittently) output greater than +1000 volts or less than −1000 volts to the electrical bushing conductor 116. In some embodiments, for example, the inventors have used 15 kilovolts to 40 kilovolt signals. Higher voltages may be used in other embodiments. Additionally and/or alternatively, the high voltage source 102 can be configured to (at least intermittently) output a time-varying high voltage to the electrical bushing 114. The high voltage source 102 can be configured to (at least intermittently) output an alternating polarity high voltage signal to the electrical bushing 114.

A second conduction path 108b can be operatively coupled to the high voltage source 102 and a second electrode 110b and can be configured to electrically interact with the flame 112.

The second conduction path 108b can include a second electrical bushing 114b. The second electrical bushing 114b can be configured to couple a portion of the second conduction path 108b external to the combustion volume 106 to the second electrode 110b.

The second conduction path 108b and the second electrode 110b can be configured to at least intermittently carry a second high voltage (e.g. opposite in polarity to the first high voltage), or an be configured to be at least intermittently coupled to ground by the high voltage source 102 and/or an electrical node in continuity with the high voltage source 102. According to an embodiment, the dielectric insulator structure 118 can be formed from one or more of glass, porcelain, ceramic, a glaze, natural rubber, a dielectric organic polymer, a dielectric silicone polymer, clay, quartz, fused quartz glass, mica, alumina, silica, feldspar, a fiber-reinforced composite, or a combination thereof.

The electrical bushing insulator conductor 116 extends from an external terminal to an internal terminal (not shown) or an electrode 110 integrated with the electrical bushing 114. For example, an internal terminal can be configured for selectable positioning of one or more electrodes 110 coupled thereto with respect to the flame 112.

The electrode 110 can be configured to extend from the electrical bushing 114 at an angle that is nonparallel with respect to a longitudinal axis of the electrical bushing conductor 116.

The electrical bushing 114 is configured to couple to other portions of the conduction path 108 via an outside terminal 212. The outside terminal 212 can include at least one of a blade connector, a ring connector, a spade connector, a threaded connector, a pressure fit or snap connector, a plug, a socket, a binding post, a lug, a miniature high voltage (MHV) connector, or a safe high voltage (SHV) connector, or a solder post.

The dielectric structure 118 can optionally include a dielectric gas, a dielectric oil, a dielectric resin, a dielectric ceramic, a dielectric polymer, a woven or nonwoven dielectric fiber impregnated with the dielectric oil, the woven or nonwoven dielectric fiber impregnated with or bonded to the dielectric resin, the woven or nonwoven dielectric fiber impregnated with or bonded to the dielectric polymer, and/or a combination thereof.

The electrical bushing conductor 116 and/or dielectric structure 118 can define a fluid flow channel (not shown). The fluid flow channel can be configured to fluidically couple the electrode 110 to an external cooling fluid source for cooling an electrode that includes internal cooling channels. The fuel nozzle 115 or portion thereof can optionally form an electrode in a system including the electrode 110 coupled to an electrical bushing 114.

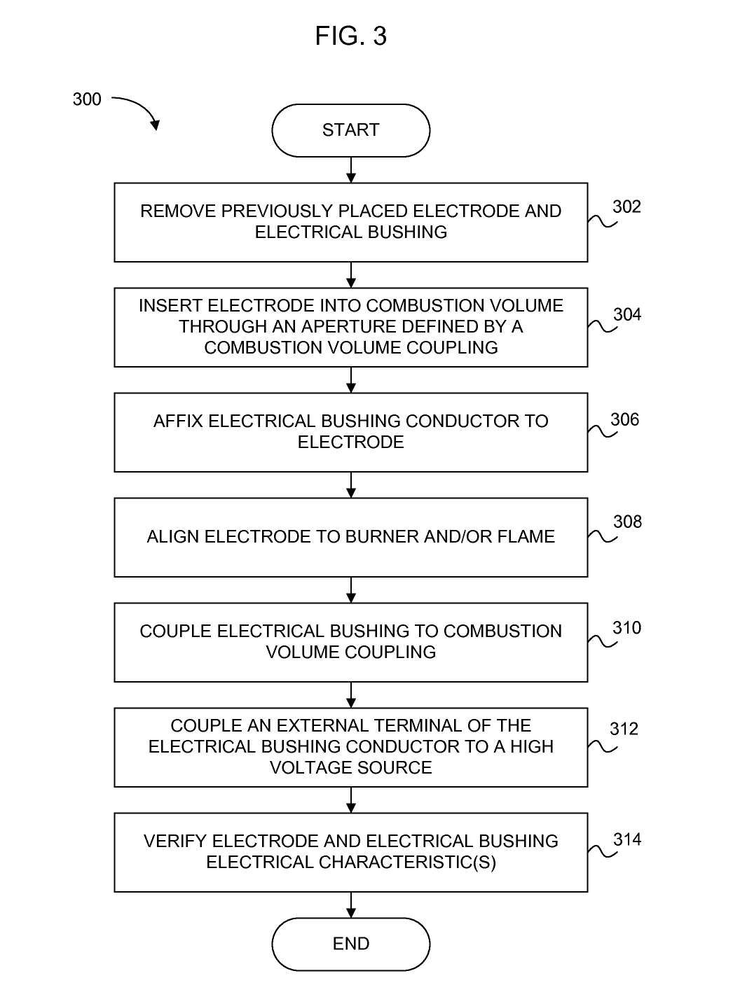

FIG. 3 is a flow chart showing a method 300 for installing the electrical bushing and electrode of FIGS. 1, 2A and 2B, according to an embodiment. In step 302, a previously placed electrode is removed. In step 304, an electrode is inserted into a combustion volume through an aperture defined by a combustion volume coupling. Step 304 is depicted in FIG. 2B. Optionally, step 304 can include squeezing a flexible (e.g., spring steel) electrode to fit through a smaller aperture in the combustion volume coupling. Proceeding to step 310, an electrical bushing including a conductor in electrical continuity with the electrode is coupled to the combustion volume coupling. In step 312, an external terminal of the electrical bushing conductor is coupled to a wire that is coupled to or configured to be coupled to a high voltage source.

As described above, an electrode can be integral with an electrical bushing (e.g., the electrode can be permanently coupled to the electrical bushing conductor or the electrode can be continuous with the electrical bushing conductor). In this case, step 306 is omitted. Alternatively, the electrical bushing can include an internal terminal configured for coupling to a separate electrode. In this case, in step 306 the electrode is coupled to the electrical bushing conductor.

Referring to step 304, the electrode can be inserted into a combustion volume through an aperture defined by a combustion volume coupling. Step 304 can include inserting an electrode having a characteristic dimension selected to fit through the aperture. Step 304 can include inserting an electrode having a major axis non-parallel with a major axis of the electrical bushing conductor. Additionally and/or alternatively, step 304 can include inserting an electrode configured, after being inserted into the combustion volume, to expand to a characteristic dimension d greater than a size D of the aperture. Causing the electrode to expand after insertion into the combustion volume through the aperture can be included in step 304.

The method 300 can include step 308 wherein the electrode is aligned to a fuel nozzle, a flame, or a fuel nozzle and a flame supported by the fuel nozzle. Various embodiments of aligning the electrode can be used. For example, step 308 can include rotating the electrical bushing within the combustion volume coupling. Another embodiment can include screwing the electrical bushing against a crush washer until a rotational alignment is reached. Aligning the electrode in step 308 can include aligning respective keys on the combustion volume coupling and the electrical bushing.

Aligning the electrode can include aligning a gauge or template on the electrical bushing with a key feature on the combustion chamber coupling. Additionally and/or alternatively, aligning the electrode can include aligning a gauge or template on the combustion chamber coupling with a key feature on the electrical bushing. Another embodiment can include driving an actuator operatively coupled to the electrical bushing, the combustion volume coupling, or the electrical bushing and the combustion volume coupling.

Referring to step 312, an external terminal of the electrical bushing conductor is coupled to a high voltage source. For example, step 312 can include attaching an electrical cable operatively coupled to the high voltage source to the external terminal. Alternatively, the electrical cable can be coupled to the high voltage source after coupling the high voltage cable to the external terminal.

The method 300 can include step 314 wherein one or more electrical characteristics of the installed electrical bushing and electrode can be verified. Step 314 can include verifying one or more electrical characteristics of the electrical bushing and the electrode such as verifying an electrical resistance between the electrode and the combustion volume coupling. Additionally and/or alternatively, verifying one or more electrical characteristics can include verifying an electrical conductivity between an electrical bushing coupling and the combustion volume coupling. Additionally, step 314 can include running a diagnostic program on the high voltage source or a controller operatively coupled to the high voltage source. The diagnostic program can be configured to verify one or more electrical characteristics of the electrical bushing and electrode.

While various aspects and embodiments have been disclosed herein, other aspects and embodiments are contemplated. The various aspects and embodiments disclosed herein are for purposes of illustration and are not intended to be limiting, with the true scope and spirit being indicated by the following claims.

What is claimed is:

1. A system configured for electrical control of a combustion reaction, comprising:
a high voltage source in a region external to a combustion volume;
a high voltage propagation path from the high voltage source to the combustion volume; and
one or more electrodes disposed in the combustion volume, operatively coupled to the high voltage propagation path, and configured to (at least intermittently) apply an electrical signal to a flame supported by a burner in the combustion volume;
wherein the high voltage propagation path includes an electrical bushing including a conductor, a dielectric insulator structure disposed peripheral to the conductor, and an electrical bushing coupling disposed peripheral to the dielectric insulator structure; and
wherein the electrical bushing is configured for in-field installation or replacement.

2. The system configured for electrical control of a combustion reaction of claim 1, wherein the electrical bushing is configured for placement and fastening using one or more screw fittings.

3. The system configured for electrical control of a combustion reaction of claim 1, wherein the electrical bushing is configured for fastening using one or more clamps.

4. The system configured for electrical control of a combustion reaction of claim 1, wherein the electrical bushing is configured for installation or replacement using hand tools.

5. The system configured for electrical control of a combustion reaction of claim 1, wherein the electrical bushing is configured for replacement without removing the burner.

6. The system configured for electrical control of a combustion reaction of claim 1, wherein the electrical bushing coupling is configured for sliding insertion into a corresponding combustion volume coupling.

7. The system configured for electrical control of a combustion reaction of claim 6, wherein the electrical bushing coupling is configured to be clamped into the corresponding combustion volume coupling.

8. The system configured for electrical control of a combustion reaction of claim 6, wherein the electrical bushing coupling is configured to form a union fitting in combination with the corresponding combustion volume coupling.

9. The system configured for electrical control of a combustion reaction of claim 1, wherein the electrical bushing coupling is configured to be rotationally free relative to a corresponding combustion volume coupling.

10. The system configured for electrical control of a combustion reaction of claim 1, wherein the electrical bushing coupling includes a key configured to select a rotation relative to the combustion volume coupling.

11. The system configured for electrical control of a combustion reaction of claim 1, wherein the electrical bushing coupling includes a gauge, template, or actuator configured for rotational adjustment relative to a key feature on the combustion volume coupling.

12. The system configured for electrical control of a combustion reaction of claim 1, wherein the combustion volume coupling includes a gauge, template, or actuator configured for rotational adjustment relative to a key feature on the electrical bushing coupling.

13. The system configured for electrical control of a combustion reaction of claim 1, wherein the electrical bushing coupling is configured for screw-in insertion into a corresponding combustion volume coupling.

14. The system configured for electrical control of a combustion reaction of claim 1, wherein at least one of the electrodes is configured to be supported by the electrical bushing in substantial electrical isolation from a combustion volume wall.

15. The system configured for electrical control of a combustion reaction of claim 1, wherein at least one of the electrodes is configured to be supported by the electrical bushing for electrical interaction with the flame.

16. The system configured for electrical control of a combustion reaction of claim 1, wherein at least one of the electrodes extends from the bushing conductor.

17. The system configured for electrical control of a combustion reaction of claim 1, wherein at least one of the electrodes is continuous with the bushing conductor.

18. The system configured for electrical control of a combustion reaction of claim 1, wherein the electrical bushing includes an electrode support operatively coupled to the dielectric insulator structure or to a conductor in electrical continuity with the electrode, the electrode support including at least a tension member, at least a compression member, or at least a stiffening member configured to maintain alignment between the electrode and the flame.

19. The system configured for electrical control of a combustion reaction of claim 1, wherein the electrode has a characteristic dimension d configured to be inserted through an electrical bushing dimension D.

20. The system configured for electrical control of a combustion reaction of claim 1, wherein the electrical bushing coupling is configured to cooperate with a corresponding combustion volume coupling to provide a low-resistance conduction path to ground from the electrical bushing coupling to the combustion volume coupling.

21. The system configured for electrical control of a combustion reaction of claim 1, wherein the electrical bushing includes a resistor between the conductor or at least one electrode operatively coupled to the conductor and the electrical bushing coupling.

22. The system configured for electrical control of a combustion reaction of claim 21, wherein the electrical resistor is integrated with the dielectric insulator structure.

23. The system configured for electrical control of a combustion reaction of claim 1, wherein the high voltage source is configured to (at least intermittently) output greater than +1000 volts or less than −1000 volts to the electrical bushing conductor.

24. The system configured for electrical control of a combustion reaction of claim 1, wherein the high voltage source is configured to (at least intermittently) output a time-varying high voltage to the electrical bushing.

25. The system configured for electrical control of a combustion reaction of claim 24, wherein the high voltage source is configured to (at least intermittently) output an alternating polarity high voltage signal to the electrical bushing.

26. The system configured for electrical control of a combustion reaction of claim 1, further comprising:
a second conduction path operatively coupled to the high voltage source and a second electrode configured to electrically interact with the flame.

27. The system configured for electrical control of a combustion reaction of claim 26, wherein the second conduction path includes a second electrical bushing configured to couple a portion of the second conduction path external to the combustion volume to the second electrode.

28. The system configured for electrical control of a combustion reaction of claim 26, wherein the second conduction path and the second electrode are configured to at least intermittently carry a second high voltage.

29. The system configured for electrical control of a combustion reaction of claim 26, wherein the second conduction path and the second electrode are configured to be at least intermittently coupled to ground by the high voltage source or an electrical node in continuity with the high voltage source.

30. The system configured for electrical control of a combustion reaction of claim 1, wherein the dielectric insulator structure is formed from one or more of glass, porcelain, ceramic, a glaze, natural rubber, a dielectric organic polymer, a dielectric silicone polymer, clay, quartz, mica, alumina, silica, feldspar, a fiber-reinforced composite, or a composite or combination thereof.

31. The system configured for electrical control of a combustion reaction of claim 1, wherein the electrical bushing insulator conductor extends from an external terminal to a combustion volume terminal or electrode.

32. The system configured for electrical control of a combustion reaction of claim 1, wherein the electrical bushing includes combustion volume terminal that is configured for selectable positioning of the one or more electrodes with respect to the flame.

33. The system configured for electrical control of a combustion reaction of claim 1, wherein the electrode is configured to extend from the electrical bushing at an angle that is nonparallel with respect to a longitudinal axis of the electrical bushing conductor.

34. The system configured for electrical control of a combustion reaction of claim 1, wherein the electrical bushing includes an outside terminal including at least one of a blade connector, a ring connector, a spade connector, a threaded connector, a pressure fit or snap connector, a plug, a socket, a binding post, a lug, a miniature high voltage (MHV) connector, or a safe high voltage (SHV) connector (or a solder post).

35. The system configured for electrical control of a combustion reaction of claim 1, wherein the electrical bushing conductor or dielectric structure defines a channel configured to fluidically couple the electrode to an external cooling fluid source.

36. The system configured for electrical control of a combustion reaction of claim 1, further comprising the burner.

37. A method for installing an electrode disposed relative to a flame in a combustion volume, comprising:
inserting an electrode into a combustion volume through an aperture defined by a combustion volume coupling;
coupling, to the combustion volume coupling, an electrical bushing including a conductor in electrical continuity with the electrode; and
coupling an external terminal of the electrical bushing conductor to a high voltage source.

38. The method for installing an electrode disposed relative to a flame in a combustion volume of claim 37, further comprising:
removing a previously placed electrode.

39. The method for installing an electrode disposed relative to a flame in a combustion volume of claim 37, further comprising:
coupling the electrode to the electrical bushing conductor.

40. The method for installing an electrode disposed relative to a flame in a combustion volume of claim 37, wherein the electrode and the electrical bushing conductor are permanently coupled to one another.

41. The method for installing an electrode disposed relative to a flame in a combustion volume of claim 37, wherein the electrode and the electrical bushing conductor are continuous with one another.

42. The method for installing an electrode disposed relative to a flame in a combustion volume of claim 37, wherein inserting the electrode into a combustion volume through an aperture defined by a combustion volume coupling includes inserting an electrode having a characteristic dimension selected to fit through the aperture.

43. The method for installing an electrode disposed relative to a flame in a combustion volume of claim 37, wherein inserting the electrode into a combustion volume through an aperture defined by a combustion volume coupling includes inserting an electrode having a major axis non-parallel with a major axis of the electrical bushing conductor.

44. The method for installing an electrode disposed relative to a flame in a combustion volume of claim 37, wherein inserting the electrode into a combustion volume through an aperture defined by a combustion volume coupling includes inserting an electrode configured, after being inserted into the combustion volume, to expand to a characteristic dimension d greater than a size D of the aperture.

45. The method for installing an electrode disposed relative to a flame in a combustion volume of claim 37, further comprising causing the electrode to expand after insertion into the combustion volume through the aperture.

46. The method for installing an electrode disposed relative to a flame in a combustion volume of claim 37, further comprising:
aligning the electrode to a burner, a flame, or a burner and a flame supported by the burner.

47. The method for installing an electrode disposed relative to a flame in a combustion volume of claim 46, wherein aligning the electrode includes rotating the electrical bushing within the combustion volume coupling.

48. The method for installing an electrode disposed relative to a flame in a combustion volume of claim 46, wherein aligning the electrode includes screwing the electrical bushing against a crush washer until a rotational alignment is reached.

49. The method for installing an electrode disposed relative to a flame in a combustion volume of claim 46, wherein aligning the electrode includes aligning respective keys on the combustion volume coupling and the electrical bushing.

50. The method for installing an electrode disposed relative to a flame in a combustion volume of claim 46, wherein aligning the electrode includes aligning a gauge or template on the electrical bushing with a key feature on the combustion chamber coupling.

51. The method for installing an electrode disposed relative to a flame in a combustion volume of claim 46, wherein aligning the electrode includes aligning a gauge or template on the combustion chamber coupling with a key feature on the electrical bushing.

52. The method for installing an electrode disposed relative to a flame in a combustion volume of claim 46, wherein aligning the electrode includes driving an actuator operatively coupled to the electrical bushing, the combustion volume coupling, or the electrical bushing and the combustion volume coupling.

53. The method for installing an electrode disposed relative to a flame in a combustion volume of claim 37, wherein coupling an external terminal of the electrical bushing conductor to a high voltage source includes attaching a high voltage cable operatively coupled to the high voltage source to the external terminal.

54. The method for installing an electrode disposed relative to a flame in a combustion volume of claim 37, further comprising:
verifying one or more electrical characteristics of electrical couplings between the high voltage source and the electrode.

55. The method for installing an electrode disposed relative to a flame in a combustion volume of claim 37, further comprising:
verifying one or more electrical characteristics of the electrical bushing and the electrode.

56. The method for installing an electrode disposed relative to a flame in a combustion volume of claim 55, wherein verifying one or more electrical characteristics includes verifying an electrical resistance between the electrode and the combustion volume coupling.

57. The method for installing an electrode disposed relative to a flame in a combustion volume of claim 55, wherein verifying one or more electrical characteristics includes verifying an electrical conductivity between an electrical bushing coupling and the combustion volume coupling.

58. The method for installing an electrode disposed relative to a flame in a combustion volume of claim 37, further comprising:
running a diagnostic program on the high voltage source or a controller operatively coupled to the high voltage source, the diagnostic program being configured to verify one or more electrical characteristics of the electrical bushing and electrode.
